(19) United States
(12) Patent Application Publication
(10) Pub. No.: US 2005/0220588 A1
(43) Pub. Date: Oct. 6, 2005

(54) Forklifts

(76) Inventors: Kevin Turnbull, County Louth (IE); Barry McGrane, County Louth (IE)

Correspondence Address: LAW OFFICES OF JACOBSON HOLMAN;PROFESSIONAL LIMITED LIABILITY COMPANY, 400 SEVENTH STREET, N.W., WASHINGTON, DC, 20004, US

(21) Appl. No.: 10/989,552

(22) Filed: Nov. 17, 2004

(30) Foreign Application Priority Data
Nov. 17, 2003 (IE) S2003-0859

(51) Int. Cl. B62B 1/00

(52) U.S. Cl. 414/467

(57) ABSTRACT

A truck mounted forklift comprises a u-shaped chassis having a rear crossbar and a pair of side plates, each of the side plates being connected to one end of the rear crossbar and projecting forwardly therefrom A lifting assembly is mounted on the chassis comprising a carriage movable forwards and backwards along the chassis, an upright boom support mounted on the carriage and an extendable boom pivotally mounted on the uppermost end of the boom support. There is provided means to pivot the boom about its mounting and means to move the carriage forwards and backwards on the chassis. In this way, the reach of the forklift may be improved while at the same time not impairing the stability and manoeuverability of the forklift. Furthermore, the weight and overhang of the forklift are not impaired by such a construction.

This invention relates to forklifts and in particular to forklift trucks of the type for mounting on the rear of a carrying vehicle, the forklift truck comprising a unshaped chassis having a rear crossbar and pair of side plates mounted at the ends of the rear crossbar and projecting forwardly therefrom, a wheel located adjacent the front of each of the side plates, a steerable rear wheel located centrally on the rear crossbar, a driver's station positioned to one side of the chassis and a motive power unit positioned on the opposite side of the chassis, the forklift truck further comprising a lifting assembly mounted on the chassis. The invention relates particularly to the mast assembly.

### BACKGROUND OF THE INVENTION

Truck mounted forklifts, otherwise referred to as piggyback forklifts have been known for many years. These piggyback forklifts may be transported to and from the premises of customers of the forklift owner on the back of an articulated truck chassis or trailer and are then used to load or unload goods to or from the trailer on those premises. Typically, these piggyback forklifts are necessarily lightweight and highly manoeuverable and must be able to travel over uneven terrain without difficulty. These piggyback forklifts are not to be confused with other more general application forklifts as there are numerous problems and design constraints applicable to truck mounted forklifts that do not strictly apply to other types of forklift trucks. Two of the most important rigid design constraints applicable to truck mounted forklifts are the total weight and length of the truck mounted forklift. It is imperative to keep the overall weight of the piggyback forklift to an absolute minimum as any additional weight will reduce the total carrying capacity of the carrying vehicle upon which the piggyback forklift is mounted. Furthermore, due to restrictions imposed on maximum overhang of piggyback forklifts on carried vehicles, the overall length of the piggyback forklift is also of great importance.

The known piggyback forklifts can be further categorized into two distinct types of forklifts, vertical mast forklifts and telescopic boom forklifts. Vertical mast forklifts typically comprise a standard lightweight mast that allows for compact storage when mounted on the back of a carrying vehicle as well as reliable performance. In addition to this, the vertical mast forklifts are recognised as being highly stable and easily manoeuverable. Telescopic boom forklifts on the other hand typically comprise a telescopic boom pivotally mounted adjacent and above the rear wheel of the forklift intermediate the driver's station and an engine unit. These telescopic forklifts have the advantage that the operators view from the driver's station is not obstructed by a vertical mast and by having a telescopic boom they have improved reach capabilities.

There are however problems with the known types of piggyback forklift trucks. One of the main problems associated with vertical mast piggyback forklifts is that they are inherently limited in their reach. This problem becomes particularly important when the piggyback forklift is being used for so called “far side” loading of a truck or trailer and the piggyback forklift must deliver goods to or retrieve goods from the opposite side of a trailer about which it is stationed. Various different devices have been proposed to overcome the problems of reach of the vertical mast forklifts such as providing extendable forks and various different pantograph devices that allow the fork carrier upon which the forks are mounted to be moved forward independently of the mast. Although effective, these devices increase the weight of the piggyback forklift and trade-offs must be made elsewhere in order to keep the overall weight of the forklift as low as possible. In addition to increasing the overall weight of the piggyback forklift these devices have the added effect of increasing the amount by which the piggyback forklift protrudes from the back of the carrying vehicle, again placing further design limitations on the piggyback forklift truck. Another problem with the known types of vertical mast forklifts is that the operator's field of vision will always be blocked to a certain extent by the vertical mast. This is undesirable.

One of the main problems associated with telescopic boom type piggyback forklifts is that when they are manoeuvering without a load the majority of the weight is concentrated at the back of the piggyback forklift over the back wheel where the telescopic boom is mounted. Having this concentration of weight towards the back wheel in a three wheeled vehicle causes problems in the lateral stability and hence manoeuverability of the piggyback forklift. The piggyback forklift will have a tendency to tilt to one side particularly if subjected to any sudden sharp turns when not carrying a load. This can often cause damage to the piggyback forklift undercarriage as well as exert undesirable pressure on the rear wheel. Furthermore, any tilting of the piggyback forklift can also lead to safety risks to the operator or personnel nearby. In order to avoid any possibility of tilting, the piggyback forklift must be manoeuvered at lower speeds than the operator would normally wish thereby slowing down any loading or unloading procedure. Again, this is undesirable as it diminishes the usefulness of the piggyback forklift.

Another problem associated with piggyback forklifts having telescopic booms is that the piggyback forklifts, when in the process of being mounted or dismounted from a carrying vehicle move towards or away from the carrying vehicle in an arc rather than directly upwards and downwards as in the case of a vertical mast piggyback forklift. This arcuate movement puts unacceptable pressure on the telescopic arm components and can result in significant wear and tear to the arm components which can ultimately lead to premature failure of the telescopic arm.

### OBJECTS OF THE INVENTION

The present invention is directed towards providing a forklift truck for mounting on the rear of a carrying vehicle that overcomes at least some of the problems associated with the known piggyback forklift trucks that is simple, reliable and efficient to use.

### SUMMARY OF THE INVENTION

According to the invention there is provided a piggyback forklift truck for mounting on the rear of a carrying vehicle comprising a unshaped chassis having a rear crossbar and a pair of side plates, each of the side plates being connected to one end of the rear crossbar and projecting forwardly therefrom. A ground engaging wheel is mounted adjacent the forwardmost end of each of the side plates and a steerable rear wheel is mounted centrally on the rear crossbar. A driver's station is mounted to one side of the chassis and a motive power unit is mounted on the other side of the chassis. The piggyback forklift further comprises a lifting assembly mounted on the chassis, the lifting assembly comprising a carriage slidably mounted on the chassis, the carriage being slidable towards and away from the rear crossbar and means to move the carriage back and forth along the chassis. The lifting assembly further comprises an upright boom support mounted on the carriage and an extendable boom pivotally mounted adjacent its proximal end on the boom support adjacent the uppermost end of the boom support. A fork carrier carrying forks is mounted on the distal end of the extendable boom and there is provided means to pivot the boom about the pivot point on the upright boom support. Finally, there are provided means for extending the or reducing the length of the extendable boom to move the fork carrier towards or away from the uppermost end of the upright boom support.

This is seen as a particularly useful construction of piggyback forklift truck. By having an extendible boom pivotally mounted on the upright boom support, the extendible boom will be able to pivot outwardly away from the boom support thereby providing improved reach to the forklift. Furthermore, the boom support is in turn mounted on a carriage which may also be moved forwards and backwards relative the rear crossbar along the chassis which will further improve the reach of the device. This will enable the forklift to be used in a wide variety of applications including “far side” loading and unloading of goods and will improve the functionality of the forklift without significantly increasing the weight of the forklift. Due to the fact that there is a pivotally mounted boom on the boom support a more compact lifting means is provided that will facilitate in the operation of the forklift.

Another advantage of this type of piggyback forklift is that the entire lifting assembly may be moved forward on the forklift chassis relative the rear crossbar so that the lifting assembly is located adjacent the front wheels of the forklift. This is particularly useful when the piggyback forklift is being operated without a load on the forks. With the weight of the lifting assembly displaced towards the front of the piggyback forklift a more even weight distribution across the piggyback forklift is achieved. This will enhance the stability and hence manoeuverability of the piggyback forklift and will reduce any tendency of the piggyback forklift to tilt while in motion. The increased stability and manoeuverability of the piggyback forklift will in turn enable the forklift operator to load and unload goods in a faster and more efficient manner than was previously possible. A further advantage of the piggyback forklift truck of the present invention is that the reach of the piggyback forklift will be improved particularly when loading or unloading goods from an elevated position when compared with standard telescopic boom piggyback forklift trucks.

Generally, the upright boom support and the extendable boom are dimensioned to allow the boom to pivot to and from a closed position whereby the boom is substantially orthogonal to the ground and an open position whereby the free end of the boom point upwards and away from the ground. By having an extendible boom that may pivot to a closed position facing substantially vertically downwards, the loading and unloading of the piggyback forklift truck is further simplified and the wear and tear on the boom components is reduced. The piggyback forklift truck may be mounted onto a carrying vehicle when the extendible boom is in this position by inserting the forks into receiving sockets on the carrying vehicle in the known manner and thereafter the forks can be lowered in a vertical direction which will raise the piggyback forklift upwards relative the carrying vehicle. The piggyback forklift will not have to be mounted onto the carrying vehicle in a wide arc as is the case with other known piggyback forklifts having telescopic booms. This facility of X-Y movement offered by the boom configuration allows for much simpler operator machine manipulation during truck mounting and maintains a standard method which will allow pressure relieving facilities to be installed.

The upright boom support further comprises a pair of spaced apart upright support arms, the extendable boom being pivotally mounted therebetween and nestable within the spaced apart upright support arms when in a closed position. This configuration will allow the extendable boom to nest within the arms thereby allowing the extendable boom to face directly downwards orthogonal to the ground. This will facilitate loading and functionality of the piggyback forklift. In another embodiment, the extendable boom is pivotally mounted on the upright boom support by way of a pivot joint, the pivot joint comprising a pair of pivot arms protruding outwardly from one of the extendable boom and the upright boom support so that the extendable boom may pivot to a closed position with the boom substantially parallel to the upright boom support. Again, this is also seen as a useful configuration as the pivot arms will space the main body portions of the extendable boom and the upright boom support apart thereby allowing the boom to pivot downwardly until it is substantially parallel with the upright boom support. The pivot arms could of course be on either the upright boom support protruding forwardly of the boom support or on the extendable boom protruding rearwards and orthogonally to the main longitudinal axis of the extendable boom. Alternatively, one pivot arm could be provided on the upright boom support and the other pivot arm could be provided on the extendable boom. The important thing is that the extendable boom and the upright boom support are held spaced apart by the pivot arms to such an extent that the boom can pivot to a position substantially parallel to the upright boom support thereby allowing vertical lift of the piggyback forklift which in turn has benefits for the loading process as well as the functionality of the piggyback forklift.

For the most part, the boom comprises a two part boom having an inner casing and an outer casing, the inner casing being slidably mounted with respect to the outer casing. The outer casing is pivotally mounted on the upright boom support and the inner casing is slidable with respect to the outer casing. A boom extension ram is connected at one of its ends to the inner casing and at its other end to the outer casing to cause sliding movement of the inner casing relative the outer casing. A hydraulic lift ram is provided to cause the extendable boom to pivot relative the upright boom support, the hydraulic lift ram being connected at one end to the carriage and at its other end to the boom. Preferably, there are provided a pair of lift rams, each of the lift rams being connected at one of their ends to the carriage and at their other end to the boom, one of the pair of lift rams being a high pressure lift ram and the other lift ram being a low pressure lift ram. A compensating jack is mounted on the boom, one end of the compensating jack being connected to the boom and the other end of the compensating jack being coupled to the fork carrier. Means to sequence the compensating jack fluid supply with the fluid supply of the lift ram are also provided as well as means to transfer excess fluid pressure from the compensating jack to the high pressure lift ram.

In another embodiment of the invention the compensating jack further comprises a compensating ram and a tilt ram, the tilt ram being operable to tilt the forks upwards or downwards with respect to the horizontal longitudinal axes. The tilt ram further comprises a tilt ram cylinder having an internal bore and tilt ram piston partially housed therein, and the compensating ram further comprises a compensating ram cylinder having an internal bore and a compensating piston partially housed therein, the internal bore of the tilt ram cylinder being greater in diameter than the internal bore of the compensating ram cylinder. The tilt ram and the compensating ram are connected together in an end to end fashion, the end of the compensating ram cylinder being connected to the end of the tilt ram cylinder.

In another embodiment of the invention the compensating jack is coupled to the fork carrier by way of a linkage mechanism, the linkage mechanism comprising a pair of elongate link arms, each of the elongate link arms being pivotally connected at one end to the compensating jack and pivotally connected at the other end to the fork carrier spaced apart from each other, one of the link arms being arcuate in shape. By having such a linkage mechanism, the direction of forces acting on the compensating jack exerted by a load on the forks will be at a smaller angle to the main axis of the compensating jack than with standard link mechanisms incorporating a solid single unit. This will ensure that the pressures and forces exerted on the compensating jack are more manageable than before. Previously, the forces could have been directed at almost right angles to the compensating jack which greatly inhibited the operation of the compensating jack and furthermore exerted large forces on the compensating jack causing the compensating jack to fail to operate and in come cases resulting in failure of the compensating jack altogether. The linkage mechanism allows the compensating jack to operate under significantly less forces than before which allows a more lightweight compensating jack to be used.

The compensating jack is housed internal the boom. There is additionally provided a side shift mechanism mounted intermediate the forks and the fork carriage to provide lateral movement of the forks relative the longitudinal axis of the forklift. Friction reducing means such as nylon pads or ball bearings are provided intermediate the inner and the outer casings.

In another embodiment of the invention there is provided a piggyback forklift truck in which the extendable boom further comprises a telescopic boom having a plurality of boom components nested together. This is seen as a useful alternative construction of extendible boom that will be compact and efficient to use.

In a further embodiment of the invention there is provided a piggyback forklift truck in which the extendable boom is pivotable to a closed position in which the boom is at an angle of between ±3° of the orthogonal with respect to the ground. By having a boom that is pivotable to this extent, it will be possible for practically vertical lift of the piggyback forklift up onto a carrying vehicle instead of through an arc which again introduces significantly less wear on the boom components while at the same time allows the user of the vehicle greater flexibility in it's operation. The boom is hexagonal in cross-section. Alternatively, the boom is square in cross-section.

In one embodiment of the invention, the carriage is further provided with a plurality of rollers and each of the side plates is further provided with a track for reception of at least one carriage roller, the carriage sliding forwards and backwards on the chassis relative the rear crossbar along the rollers in the tracks. This is seen as a simple and robust way to allow the carriage to slide relative the chassis. The tracks may be formed integrally with the side plates for maximum rigidity of the entire assembly or alternatively they can be provided separately and attached to the side plates of the chassis.

The main advantage of the present invention is that the piggyback forklift will have improved reach capabilities without having to provide additional pantograph or roller arrangements for the forks and furthermore, the piggyback forklift will have increased stability when manoeuvering due to the centre of gravity being displaced forwardly on the vehicle.

### BRIEF DESCRIPTION OF THE DRAWINGS

The invention will be more clearly understood from the following description of some embodiments thereof given by way of example only with reference to the accompanying drawings in which:—

FIG. 1 is a front perspective view of a piggyback forklift according to the invention with the extendable boom in a closed fully extended configuration;

FIG. 2 is a front perspective view of the piggyback forklift of FIG. 1 with the extendable boom in a closed fully retracted configuration;

FIG. 3 is a front perspective view of the piggyback forklift of FIG. 1 with the extendable boom raised and fully retracted;

FIG. 4 is a front perspective view of the piggyback forklift of FIG. 1 with the carriage moved forward on the chassis relative the rear crossbar and the extendable boom raised and fully extended:

FIG. 5 is a front perspective view of the piggyback forklift of FIG. 1 with the carriage moved forwards on the chassis relative the rear crossbar and the extendable boom in an open fully extended configuration;

FIG. 6 is a front perspective view of the piggyback forklift of FIG. 1 with the carriage moved forwards on the chassis relative the rear crossbar and the boom in a closed fully extended configuration;

FIGS. 7(a) to FIG. 7(g) are side views of the piggyback forklift according to the invention carrying a load with the carriage and extendable boom in various different configurations;

FIGS. 8(a) to FIG. 8(d) inclusive are side views of a piggyback forklift according to the invention being mounted onto a carrying vehicle;

FIG. 9 is a side view of a truck mounted forklift according to the invention gripping a “near side” load;

FIG. 10 is a side view of the truck mounted forklift according to the invention gripping a “far side” load;

FIG. 11 is a front perspective view of a lifting assembly for use with a piggyback forklift according to the invention;

FIG. 12 is a rear perspective view of the lifting assembly of FIG. 11;

FIG. 13 is a side cross-sectional view of the lifting assembly of FIGS. 11 and 12;

FIG. 14(a) and FIG. 14(b) are side views of the linkage mechanism used with the lifting assembly according to the invention with the fork carrier at different angles of tilt relative the boom;

FIG. 15(a) and FIG. 15(b) are side views of a standard linkage mechanism with the fork carrier at different angles of tilt relative the boom;

FIGS. 16(a) to FIG. 16(d) are schematic representations of the various hydraulic rams operable on the lifting assembly and the flow of fluid therebetween; and

FIG. 17 is a stability triangle diagram comparing the centre of gravity of an unloaded piggyback forklift of the present invention to the centre of gravity of a known unloaded telescopic boom piggyback forklift.

### DETAILED DESCRIPTION OF THE PREFERRED EMBODIMENTS

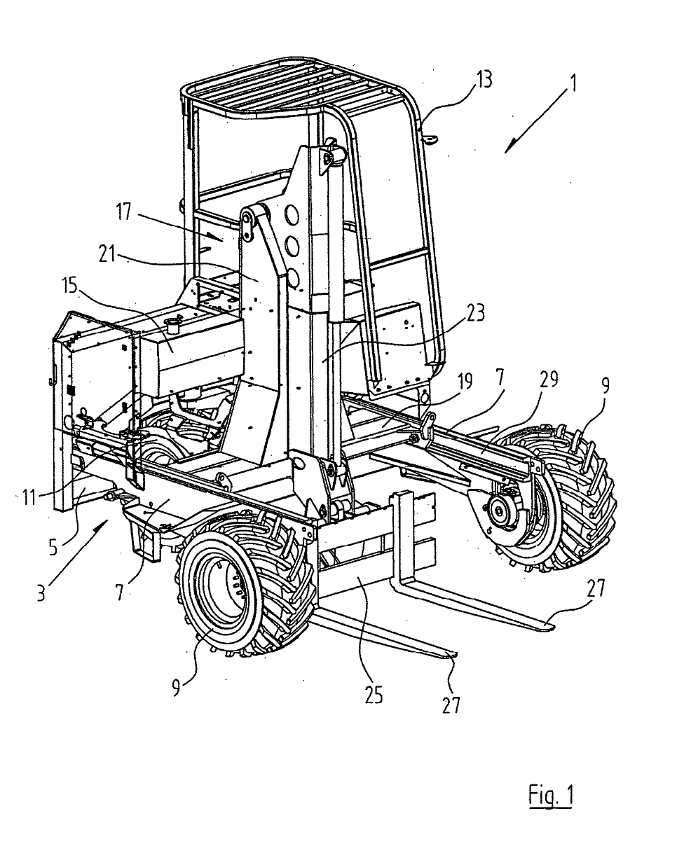

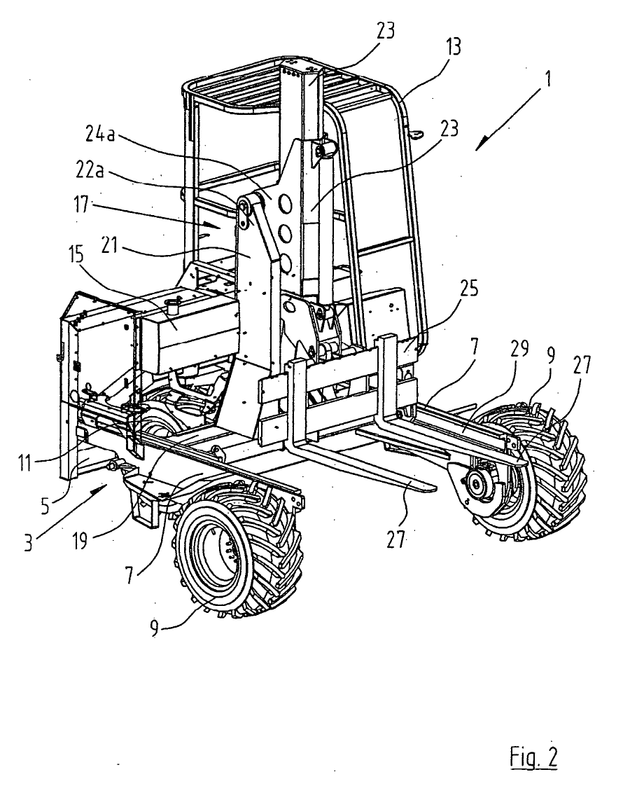

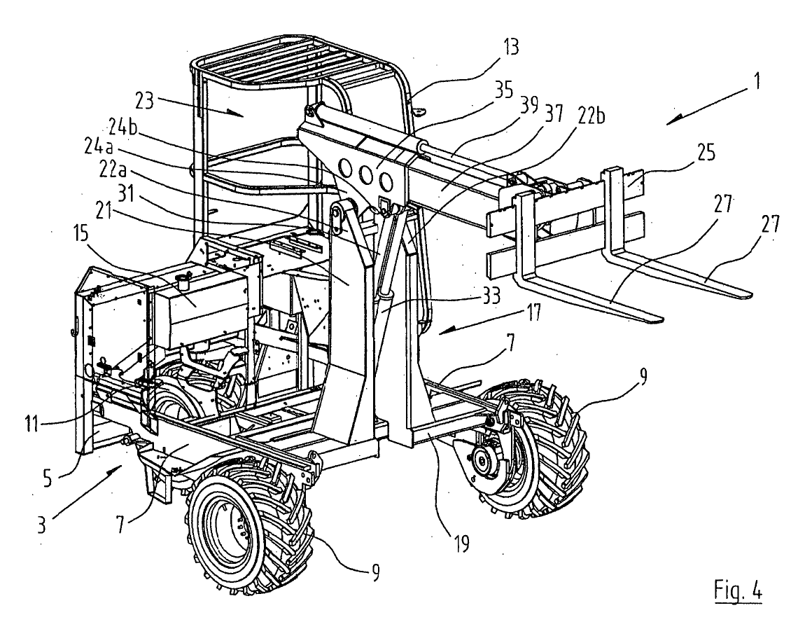

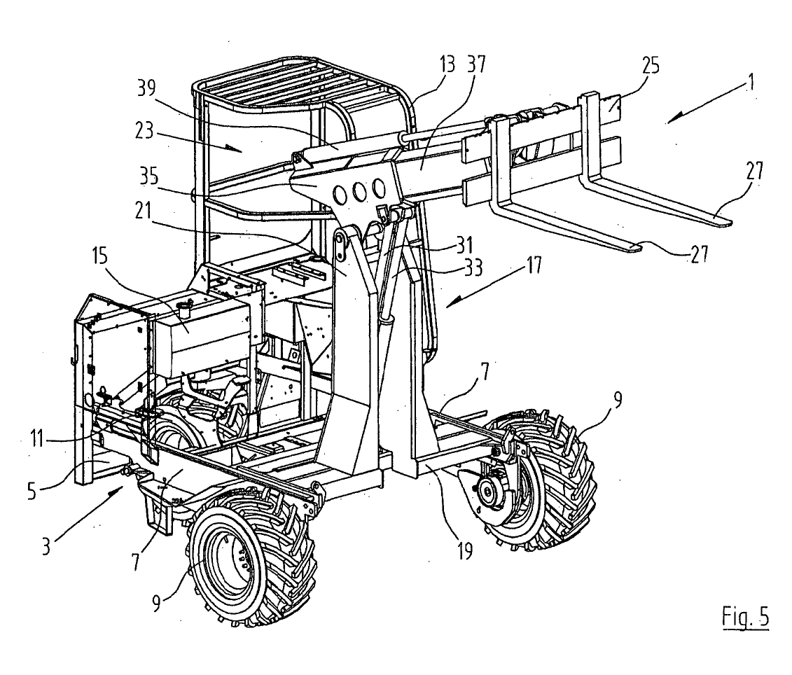

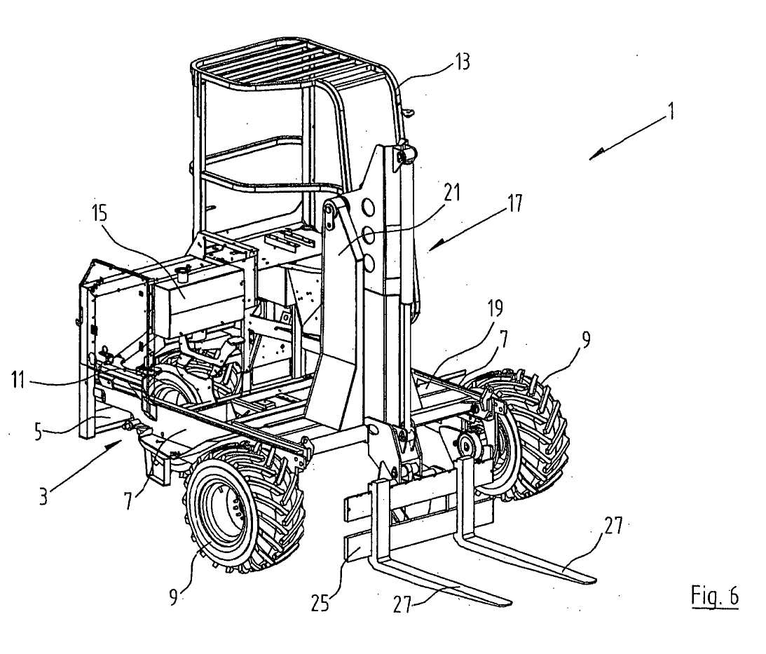

Referring to the drawings and initially to FIGS. 1 to 6 thereof there is shown a piggyback forklift truck 1 for mounting on the rear of a carrying vehicle comprising a u-shaped chassis 3 having a rear cross member 5 and a pair of side plates 7 mounted at the ends of the rear cross member 5 and projecting forwardly therefrom. A wheel 9 is located adjacent the front of each of the side plates and a steerable rear wheel 11 is located centrally on the rear cross member. A driver's station 13 and a motive unit 15 are mounted on opposite sides of the chassis relative to each other and there is further provided a lifting assembly, indicated generally by the reference numeral 17. The lifting assembly 17 further comprises a carriage 19 slidably mounted on and moveable forwards and backwards relative the rear crossbar along the side plates and an upright boom support 21 mounted atop the carriage and projecting upwardly therefrom, an extendible boom 23 is pivotally mounted adjacent its proximal end on the boom support adjacent to the uppermost end of the boom support and has a fork carrier 25 mounted on the distal end of the extendable boom carrying a pair of lifting forks 27 thereon. The carriage is provided with rollers (not shown) which are mounted in tracks 29, only one of which is shown, on the side plates and there is provided means to move the carriage (not shown) forwards and backwards along the tracks on the side plates.

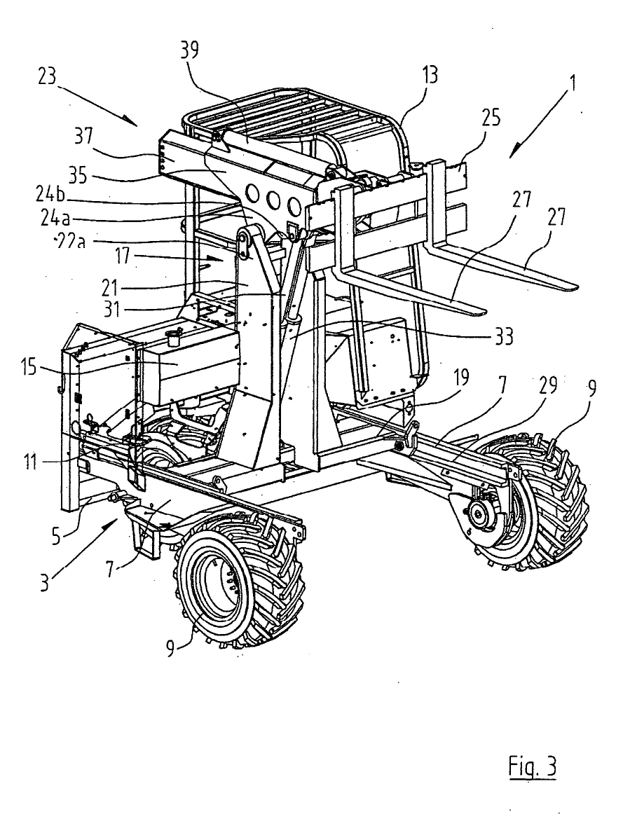

Referring specifically now to FIGS. 3 to 5 inclusive there is shown means to pivot the boom about its mounting provided by a pair of lift rams 31, 33, which are mounted at one end to the carriage and at their other end to the boom. Extension of the lift rams 31, 33 will cause the boom to pivot upwardly from a closed configuration with the boom facing substantially vertically downwards and substantially orthogonal to the ground to an open configuration in which the boom faces outwardly and upwardly away from the upright boom support. The extendible boom 23 further comprises a two part boom having an outer casing 35 pivotally mounted to the boom support and an inner casing 37 slidably mounted with respect to the outer casing and retained therein. An elongate hydraulic extension ram 39 is provided and connected at one end to the outer casing and at its other end to the inner casing. Operation of the extension ram 39 will cause extension or retraction of the inner casing relative the outer casing. Nylon pads (not shown) are provided intermediate the inner and outer casings to prevent excessive wear and tear and to facilitate movement between the outer and inner casings.

The upright boom support further comprises a pair of spaced apart upright support arms, 22a, and 22b. The extendable boom further comprises a pivot joint which in turn comprises a pair of pivot arms 24a, 24b and is pivotally mounted to the spaced apart upright support arms 22a, 22b by way of the pivot arms 24a, and 24b. The extendable boom 23 may pivot about the pivot arms on the spaced apart upright support arms from a fully open position to a fully closed position whereby the extendable boom is substantially parallel to the upright boom support and orthogonal to the ground. In the fully closed position (FIGS. 1, 2 and 6), the extendable boom is nestable within the spaced apart upright support arms 22a, 22b.

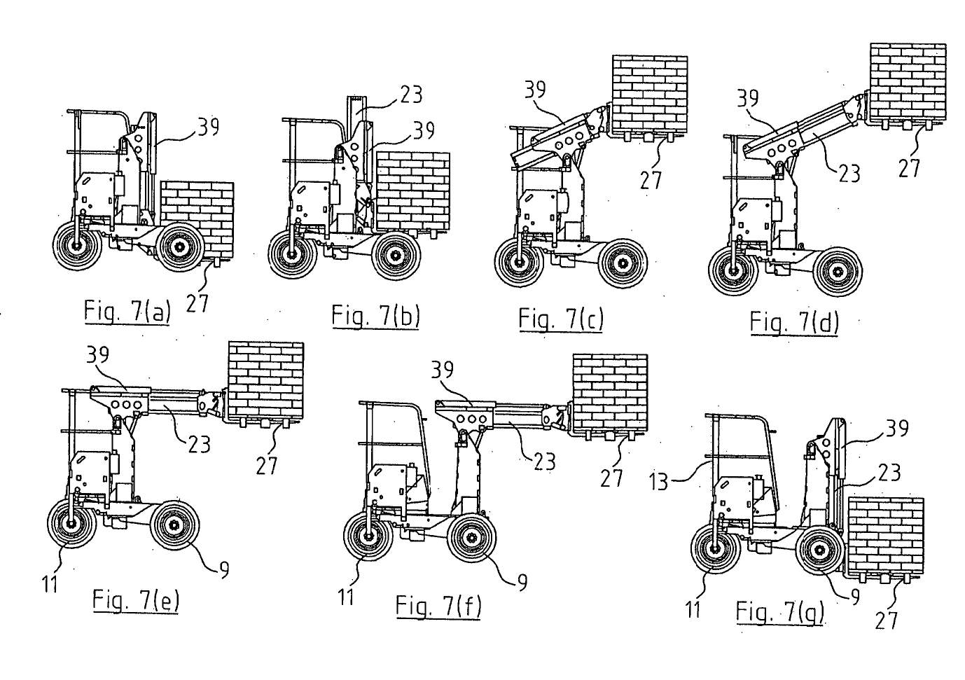

Referring to FIGS. 7(a) to 7(g) inclusive there is shown a number of side views of the forklift truck in operation. In FIG. 7(a) the forklift trucks lifting assembly carriage is in a fully aft position on the side plates 7 and extension ram 39 is extended so that the lifting forks 27 are located adjacent the ground between the two side plates 7. In this way a load, shown here as a pallet of bricks, may be lifted between the side plates 7 for maximum stability. In FIG. 7(b) the load is raised off the ground by retraction of the extension ram 39 to its fully retracted position, the load may then be transported to its desired destination in this configuration. Once the extension ram has been fully retracted the load is lifted upwards further by pivoting the extendable boom 23 by manipulation of the lift rams 31, 33, which may be operated until the extendable boom is in a fully open position with the boom facing upwardly and away from the boom support as seen in FIG. 7(c). The boom is then extended by operation of the extension ram 39 until in a fully extended position as seen in FIG. 7(d) whereafter the load may be deposited in the desired location.

Maximum forward reach is achieved by pivoting the boom 23 by operation of the lift rams 31, 33 until the boom is orthogonal to the boom support and substantially parallel to the ground (as shown in FIG. 7(e)) and subsequently moving the carriage and hence the entire lifting assembly forwards relative the side plates until the forklift is in the configuration shown in FIG. 7(f). Finally, the forklift may be used to pick up goods which are positioned forward of the front wheels by simply having the boom in a fully closed position with the inner casing extended to a position adjacent the ground and then subsequently moving the entire carriage forwards until the forks are in engagement with the load whereafter the load may be transported as desired. It will be understood that the above steps are not intended as a series of strict sequential steps and are only shown to demonstrate the wide flexibility of movement of the piggyback forklift with the lifting assembly. The extension of the boom could be carried out prior to the boom being brought to the fully open configuration as shown in FIG. 7(c) or could even be carried out simultaneously as the boom is being raised.

It will be understood that stabilizers (not shown) will be provided on the forklift which may be deployed at appropriate times to prevent overbalancing of the forklift during loading and unloading operations. This will be almost certainly necessary when attempting maximum reach with heavy loads on the forks. The nature of the stabilizers and their deployment would be readily understood by the person skilled in the art and will not be discussed further in this application.

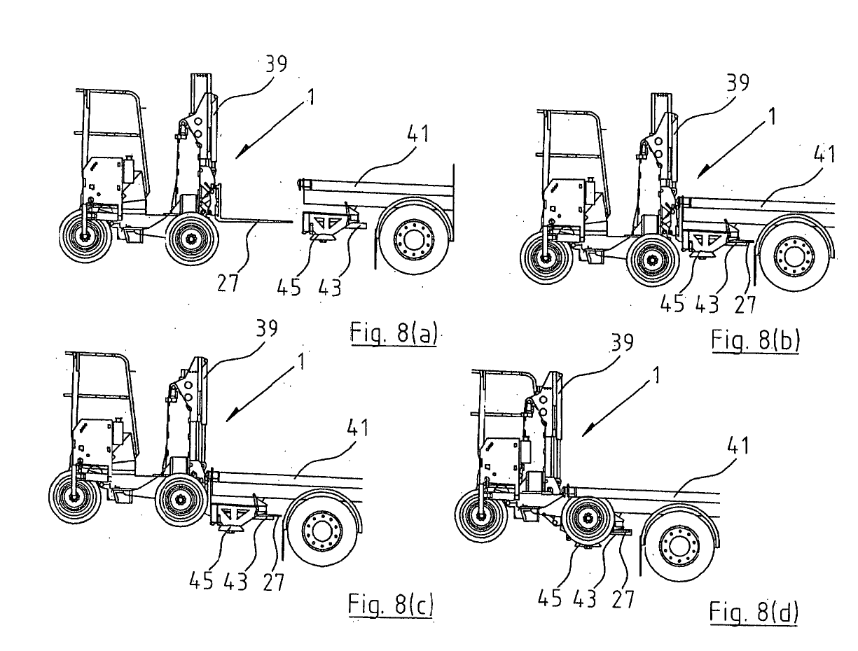

Referring to FIGS. 8(a) to 8(d) inclusive there is shown the sequential steps in mounting a truck mounted forklift 1 according to the invention onto the rear of a carrying vehicle 41. In FIG. 8(a) the truck mounted forklift has its carriage in a substantially forward position with respect to the side plates and the boom is in a retracted although not necessarily fully retracted position. The lifting forks 27 are inserted into specially adapted fork receiving sockets 43 mounted on the undercarriage of the carrying vehicle 41 until the heel of the lifting forks bear against the entrance of the sockets. Once the lifting forks are fully inserted into the sockets (FIG. 8(b)) the operator of the vehicle (not shown) causes a manual tilt of the forks via an appropriate tilt mechanism to tilt the forks upwards which will cause the upper portion of the forklift to lean inwardly with respect to the carrying vehicle. The extension ram 39 is then operated to extend the boom which causes the piggyback forklift to rise off the ground (FIG. 8(c)).

Once the piggyback forklift is fully off the ground the means to move the carriage forwards and backwards along the chassis relative to the rear crossbar is operated to move the carriage to a fully aft position relative the rear crossbar. This in turn will cause the rest of the piggyback forklift to move forwards relative the carrying vehicle until the wheels and part of the side plates 7 are located underneath the undercarriage of the carrying vehicle, as shown in FIG. 8(d). The wheels 9 will rest on steps 45. Additional locking members may be provided to secure the forklift in position relative the carrying vehicle. By incorporating such a system the mounting movement of the piggyback forklift onto the carrying vehicle is practically vertical as opposed to the known telescopic boom devices in which the piggyback forklift would be lifted in an arcuate path onto the carrying vehicle which can cause wear and tear to the lifting components. Furthermore, the operator may remain in the vehicle at all times during the mounting dismounting process.

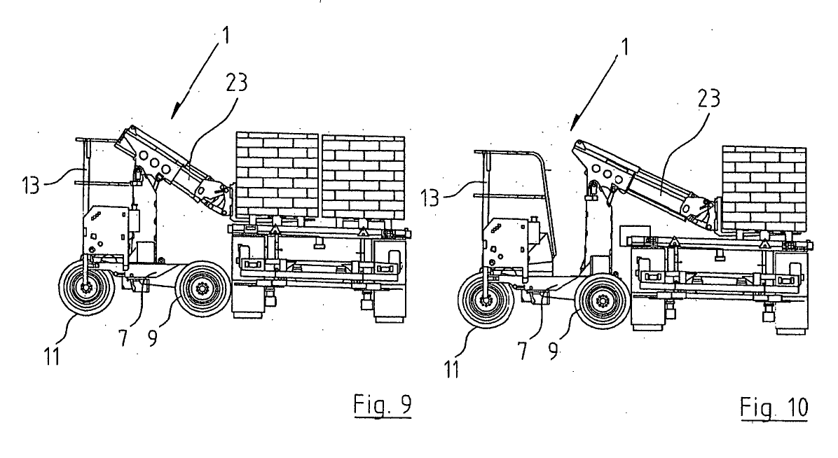

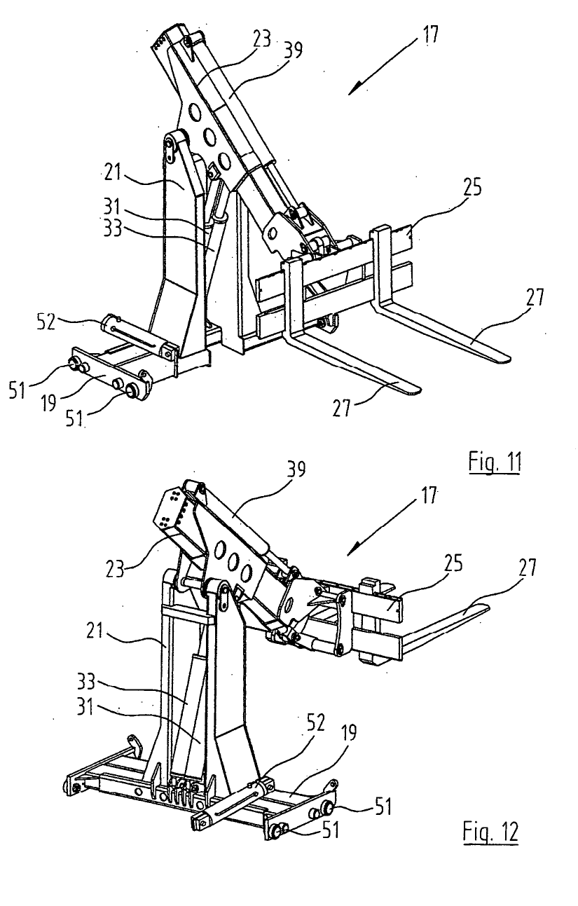

Referring to FIGS. 9 and 10 there is shown the piggyback forklift truck according to the invention in operation unloading goods from a flatbed truck. In FIG. 10 the boom may be fully extended and the carriage moved to a forwardmost position relative the sidearms to allow a “far side” load to be collected by the forklift. No additional rollers or pantograph system is required to reach the far side of the flatbed truck.

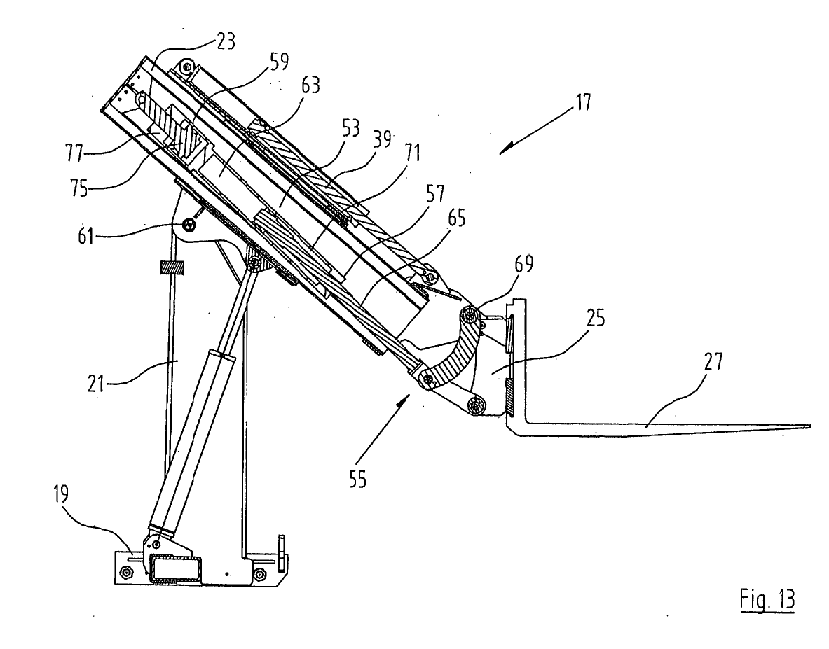

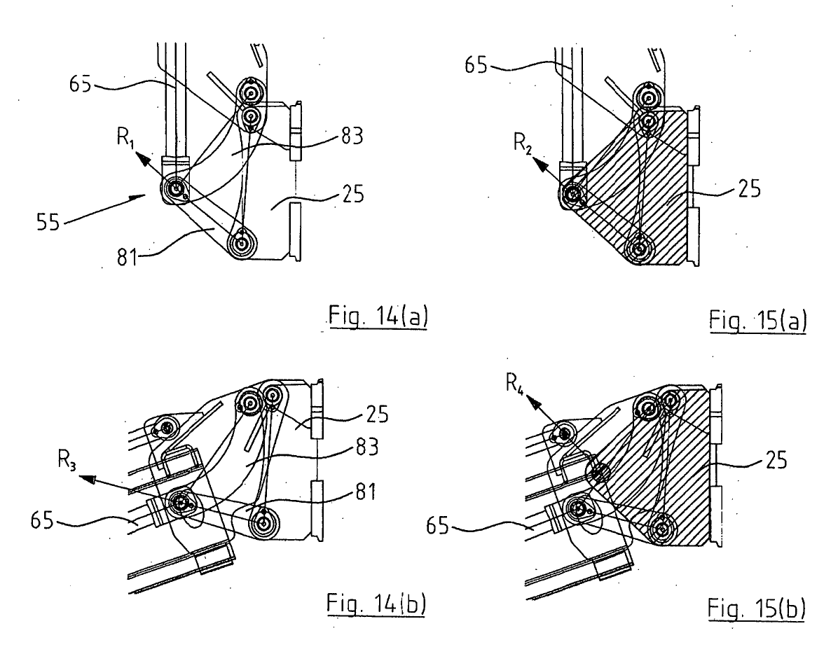

Referring to FIGS. 11 and 12 there is shown a pair of perspective views of the lifting assembly 17 for use with the piggyback forklift according to the invention. The lifting assembly 17 comprises a carriage 19 upon which there is mounted a vertical boom support 21 projecting upwardly therefrom. An extendible boom 23, comprising an outer casing 35 and an inner casing 37 is pivotally mounted adjacent the upper part of the boom support. The inner casing 37 is slidably mounted inside the outer casing 35 which is in turn pivotally mounted on the boom support. A pair of lift rams 31, 33 are provided to pivot the boom relative the boom support about its mounting and an extension ram 39 is provided to extend and retract the inner casing of the boom relative the outer casing. One of said lift rams is a high pressure lift ram capable of withstanding pressures up to 450 bar while the other is a low pressure ram capable of withstanding pressures of up to 330 bar. Rollers 51 are provided on the carriage for engagement in the tracks (not shown) of the side plates. There is further shown means to move the carriage back and forth along the chassis provided by a ram 52 connected at one end to the carriage 19 and at its other end to the chassis (not shown). Operation of the ram 52 will cause the carriage to move on the rollers 51 in the tracks forwards and backwards on the chassis relative the rear crossbar.

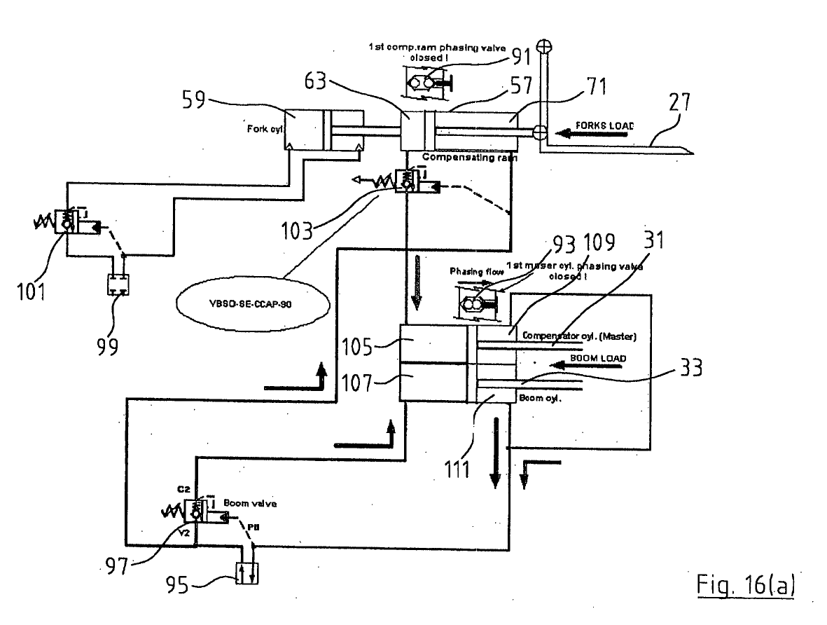

Referring to FIG. 13 there is shown a cross-sectional side view of the lifting assembly shown in FIGS. 11 and 12. The lifting assembly further comprises a compensation jack 53 and a linkage mechanism 55 which will be described in greater detail below. The compensating jack is connected at one of its ends to the boom and connected at its other end to the fork carrier via the linkage mechanism and further comprises a back-to-back duplex ram comprising a compensating jack ram 57 and a controllable tilt ram 59. The compensating jack ram 57 is responsive to the orientation of the boom and operable on the fork carrier to maintain the forks in a fixed orientation with respect to the ground during raising or lowering of the boom. The controllable tilt ram 59 is operable as a controllable tilt for manipulation by the operator of the forklift to manually tilt the forks by a predetermined amount. The fluid supply of the compensating jack ram is sequenced with the fluid supply of the high pressure lift ram 31 so that as the fluid supply in the high pressure lift ram changes as the boom is raised or lowered so too will the fluid supply to the compensating jack ram change. The fluid supply to the compensating jack ram is inversely proportional to the fluid supply to the high pressure lift ram.

In use, as the extendable boom is raised the lifting rams 31, 33 are extended by pumping fluid into the cylinder bore (not shown) of the low pressure lift ram and the rod-end of the compensation ram where the bore of the compensation ram feeds directly into the bore of the high pressure lift ram. This causes the boom to pivot about its mounting point 61 on the boom support. As the boom rises upwards fluid is drawn from the cylinder bore 63 of the compensating jack ram which may be fed to the high pressure lift ram 31 by way of a hydraulic circuit, not shown. As the fluid is drawn from the cylinder bore 63 the piston 65 will retreat into the cylinder bore acting also under the weight of the forks 27 and fork carrier 25. In this way, as the boom raises upwards, the forks and fork carrier will pivot clockwise (in the orientation shown) about pivot point 69 connecting the fork carrier to the boom, this will cause the forks to remain in a fixed orientation with the ground as the boom is being raised. In certain circumstances it may be desirable to pump fluid into cavity 71 on the piston side of the compensating jack to positively force the piston inwardly thereby causing the forks to rotate. This may be necessary if there is no load on the forks and their weight is not sufficient to maintain the forks in a fixed relationship with the ground. It will be understood that when the boom is being lowered the opposite hydraulic fluid motion occours, namely, fluid is pumped into the compensating jack ram cylinder bore 63 and drawn from the lift rams 31, 33 to cause the forks to stay level and to lower the boom respectively. A reset valve is provided on the compensating jack to allow recalibration of the sequencing of the compensating jack and the lift jack.

The controllable tilt ram 59 comprises a piston 75 mounted in a tilt ram cylinder bore 77. The piston is attached at one end to the boom. The controllable tilt ram 59 has a cylinder bore diameter greater than that of the compensating jack ram. In certain circumstances, for example when mounting a carrying vehicle, it may be desirable for the operator of the vehicle to provide additional tilt to the forks thereby altering their orientation with respect to the ground. This will not affect the operation of the compensating jack ram which merely maintains the orientation of the forks relative the ground that has been determined by the controllable tilt ram. For example, it may be desirable to add tilt to the forks when dropping off or picking up a load. The operator of a vehicle may decide to provide a downward pre-tilt to the forks when dropping off goods or an upward pre-tilt to the forks once they have been engaged and are to be transported. In order to do this, fluid is either delivered to or drawn off from the tilt ram cylinder bore. This causes the entire compensating jack to move towards or away from the end of the boom remote from the fork carrier as the amount of fluid in the compensating jack ram cylinder bore will remain constant unless the boom is also being moved at that time. This in turn will act on the link mechanism to cause the forks to rotate about pivot point 69. In this way, the operator may essentially cause the forks to rotate so that they are no longer parallel to the ground and are tilting upwards or downwards as required.

What is important to note is that the compensating ram will keep the forks in a fixed orientation with the ground. The position of the forks relative the boom will be altered by the compensating ram in response to upwards or downwards movement of the entire boom caused by the lifting ram but the forks will maintain their orientation with the ground throughout. Only when the tilt ram is adjusted will the forks orientation with the ground be altered. The tilt ram can therefore be used to effectively override the compensating ram if need be although the tilt ram is only adjustable to a very small degree compared with the compensating ram as the stroke of the tilt ram is significantly less than the stroke of the compensating ram.

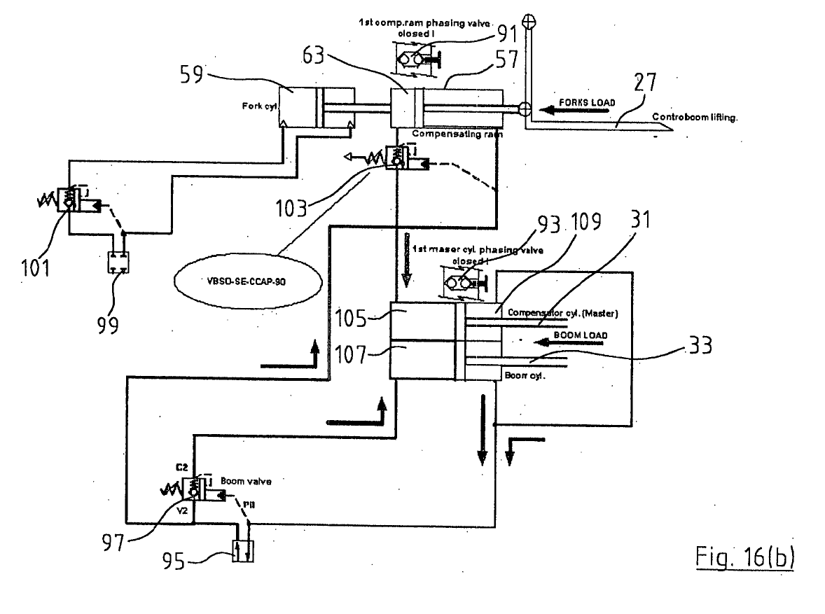

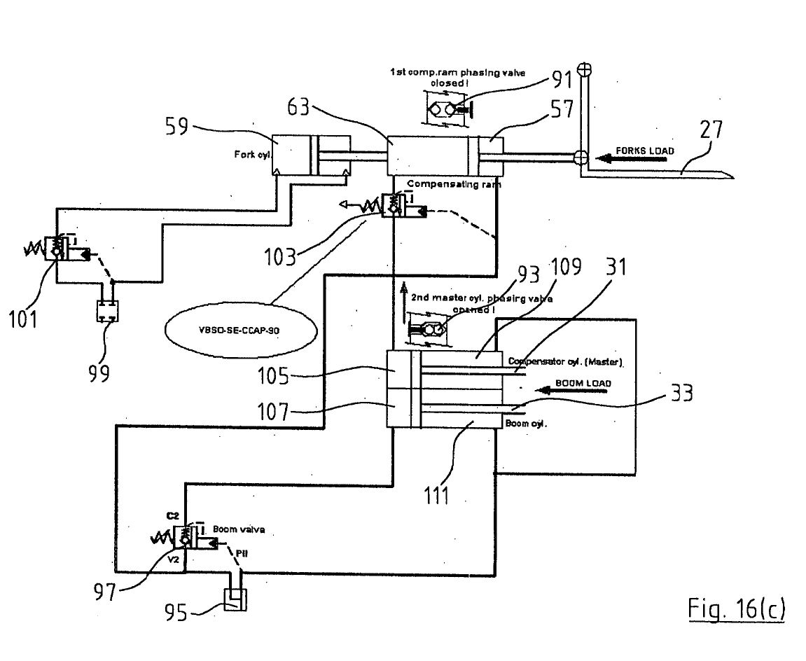

Referring now to FIGS. 14(a) to 15(b) inclusive there is shown the linkage mechanism 55 of the present invention in greater detail compared with a known linkage mechanism. Referring specifically now to FIGS. 14(a) and 14(b) the linkage mechanism further comprises a first link member 81 pivotally mounted at its ends to the compensating jack ram piston 65 at one end and the fork carrier 25 at its other end and a second link member 83 pivotally mounted to the compensating jack ram piston 65 at one of its ends and the extendible boom 23 at its other end to spread the loading on the compensating ram and redirect the forces acting on the compensating ram. The second link member 83 is arcuate in shape. By having such a link mechanism it can be seen that the angle between the direction of force applied by the forks, indicated by the arrow R1 and R3, and the longitudinal axis of the compensating jack is sufficiently small regardless of whether or not the forks are perpendicular to the longitudinal axis of the boom such as when the boom is fully lowered, or when the forks are substantially parallel to the longitudinal axis of the boom such as when the boom is fully raised. This enables the compensating ram to provide an equal but opposite force and provide tilt to the forks when necessary. By having the linkage mechanism the angle described may be kept relatively small at all times. By keeping the angle small at all times, the pressures exerted on the forks are not excessive and therefore continuous operation of the compensation jack can be obtained with a less heavy duty compensation jack.

Referring to FIGS. 15(a) and 15(b) a standard solid bracket is substituted for the link mechanism. It can be seen that the angle between the direction of force R2 and the longitudinal axis of the compensating jack is virtually identical to the angle between the direction of force R1 and the longitudinal axis of the compensating jack for the link mechanism when the forks are substantially perpendicular to the longitudinal axis of the boom. However, when the boom is raised and the forks are substantially parallel to the longitudinal axis of the boom, the angle between the position and direction of force R4 and the longitudinal axis of the compensating jack is far greater than the angle between the direction of force R3 and the longitudinal axis of the compensating jack for the link mechanism. This causes increased stresses and strains on the compensating jack as the angle of action is much larger for the same force and in the worst case the compensating jack will not be able to function. This therefore requires the provision of a larger, heavier compensating jack which is undesirable as it would increase the weight of the device and would necessitate a larger diameter boom. The link mechanism obviates the need for more robust compensating rams.

In the embodiment described above the forks were described as being substantially parallel to the longitudinal axis of the boom. In fact the forks would have turned through an angle of in the region of 110° from their position perpendicular to the longitudinal axis of the boom so would have passed through the parallel and are in fact angled 20° beyond parallel. It is important to note that the forks are shown in their neutral position and a further −8° of tilt could be applied by the operator thereby further rotating the fork clockwise which would create an even larger angle for the known systems. The link mechanism described can therefore cut down significantly the size of compensating jack that is required.

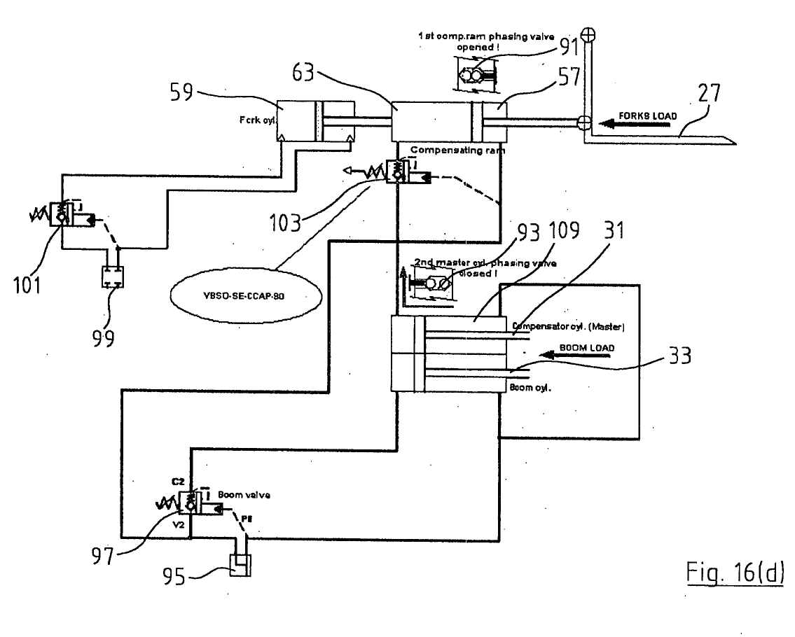

Referring to FIG. 16(a) to FIG. 16(d) inclusive there is shown a schematic representation of the hydraulic rams operable on the lifting assembly, where like parts have been given the same reference numeral as before, including the compensating jack ram 57 and controllable tilt ram 59 connected to the forks 27 via fork carrier (not shown), as well as the lift rams 31, 33 connected to the boom (not shown). The compensating jack ram further comprises a compensating jack ram phasing valve 91 and the high pressure lift ram 31 further comprises a boom supporter cylinder phasing valve 93. Control of the lifting and lowering of the extendible boom is carried out through controller 95 and associated boom valve 97 whereas control of the adjustment of the controllable tilt ram 59 is carried out through tilt controller 99 and associated tilt cylinder 101. There is further provided compensation valve 103.

In use, when the extendible boom is being lifted (FIGS. 16(a) & 16(b)), fluid is delivered to or drawn from the various cylinders in the manner shown by the arrows. Fluid is delivered to cylinder bore 107 of low-pressure lift ram 33 and to cylinder rod-end 71 of the compensation ram 57. The cylinder bore of this cylinder feeds directly into the cylinder bore 105 of the high-pressure lift ram 31. The pressure generated in cylinder bore 105 of the high-pressure lift ram 31 is the cumulative sum of the pressure caused by the fluid feed into rod-end 57 and the induced pressure caused by the loading of the forks 27.

When the extendible boom is being lowered (FIGS. 16(c) & 16(d)), fluid is delivered to cylinder rod-ends 109 and 111 of the high-pressure lift ram 31 and low-pressure lift ram 33 respectively. The displacement caused in cylinder bore 105 of the high pressure lift ram 31 is diverted to cylinder bore 63 of the compensation ram 57. This arrangement allows the weight of the mechanism to work to keep the forks aligned while lowering the mechanism. The flow of oil from cylinder bore 107 of the low-pressure lift ram 33 is controlled by over-center valve 97 to ensure that the boom is always supported by both lift rams.

The boom also employs a reset function to allow an operator to realign the high-pressure lift ram 31 and the compensation ram 57. This is achieved by manner of valves 91 and 93 which are installed in the piston heads of compensation ram 57 and the high-pressure lift ram 31 respectively. These valves allow free flow through the piston head when the respective cylinders are in the closed position. This reset function can only be preformed under unloaded conditions. These valves do not allow for free flow of oil in conditions which would cause the boom to lower. During reset an operator would be required to close the boom mechanism fully and apply pressure for 5 seconds. This applies pressure to cylinder rod-ends 109 and 111 of the high-pressure lift ram 31 and the low-pressure lift ram 33 respectively. If the high-pressure lift ram 31 reaches the end of it's stroke before the compensation ram 57 then the valve in the piston head of the high-pressure lift ram 31 would allow free flow from the rod-end 31 to the bore end 105 of this cylinder and subsequently would extend the compensation ram 57 to the fully open position thus realigning the rams.

If, however, the compensation ram 57 were to reach the end of its stroke before the high-pressure lift ram 31 then this action would not correct the error. Therefore, as part of the reset operation the operator would also be required to open the boom mechanism fully and apply pressure for 5 seconds. This applies pressure to the cylinder rod-end 57 of the compensation ram 57. The compensation ram 57 would reach its closed position before the high-pressure lift ram 31. The valve in the piston head of the compensation ram 57 would then allow free flow from cylinder rod-end 57 to cylinder bore 63 and subsequently would extend the high-pressure lift ram 31 to its fully open position thus fully realigning the rams. This action could only be undertaken in an unloaded condition as the low-pressure lift ram 33 needs to be able to lift and support the mechanism on its own. If this action were attempted when the machine were loaded then back-pressure would caused the free-flow across the cylinder head in the compensation ram 57 to stop and the rams would not realign but the mechanism would continue to support it-self using both lift rams 31 and 33.

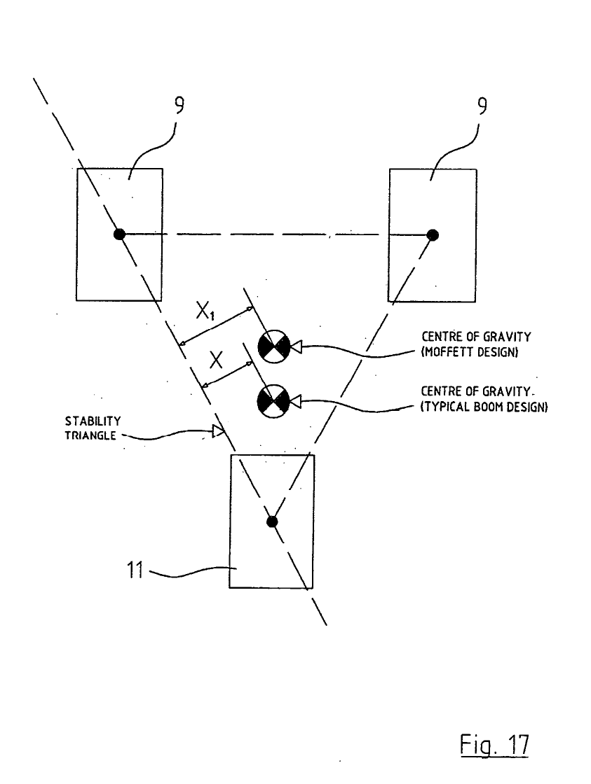

Referring to FIG. 17 of the drawings there is shown a stability triangle diagram of the forklift according to the present invention compared with a typical boom design forklift. With a machine having a typical boom design, the centre of gravity of the machine is close to the back wheel of the machine. This means that the distance between the centre of gravity and the side of the stability triangle will be quite small (indicated as X in the diagram). With the centre of gravity being so close to the stability triangle side the machine will be less stable. With the forklift according to the present invention, the centre of gravity will be moved forwards on the machine further away from the back wheel. This will cause the distance of the centre of gravity to the side of the stability triangle (indicated as X₁ in the diagram) to be increased thereby increasing the stability of the machine. The positions shown are for forklifts that are not loaded. The range of tilt possible while maintaining stability is much greater for the truck mounted forklift according to the invention.

In the embodiments given the extendible boom is described as a two part boom with an outer casing and an inner casing that slides relative the outer casing. It will be understood that by extendible in this case it may not necessarily mean the boom that is extendible in length but rather the boom which is extendible in reach. Instead of the two part boom it is envisaged that a telescopic extendible boom could also be provided in which at least one boom support section is nested within another boom support section and will allow extension of the boom thereby extending the reach of the boom. The telescopic boom is also therefore an extendable boom within the meaning of the specification.

In the embodiments described it is mentioned that the fluid supply of the high pressure lift ram may be sequenced with the compensating jack ram. It is envisaged that there may be provided a fluid connector between the cylinder bore of the compensating ram and the cylinder bore of the lifting ram with a series of valves. On the forks having a load placed thereon, additional pressure will be induced onto the fluid contained in the compensating ram cylinder bore by virtue of the fact that the weight of the load on the forks will tend to push the piston inwardly into the cylinder bore. The additional pressure build up can then be transferred to the cylinder bore of the high pressure lift ram by way of the fluid connector and series of valves to assist in the lifting of the boom.

In the embodiments described the section of the boom is shown to be hexagonal in cross-section. Alternatively the boom could in fact be square in cross section. It is envisaged that instead of being directly perpendicular to the ground the boom could be at an angle of between ±10° of the orthogonal with respect to the ground. This is sufficient to obtain the main advantages from the invention. It is further envisaged that the fork carrier could be provided with a shift mechanism to allow sideways movement of the forks relative the fork carrier. This will allow adjustment of the forks without having to readjust the position of the forklift. In the embodiments described above, the linkage mechanism has been described in relation to piggyback forklifts only. It will be clearly understood however that the linkage mechanism could also be used in connection with many other different types of pivoting booms and not solely with the pivoting extendable booms described. In addition to this, the linkage mechanism is in no way restricted to use solely with truck mounted forklifts and could find applications in other types of forklift and industrial machinery. Furthermore, the linkage mechanism could be used in connection with other end attachments such as a bucket or other arrangement and is not restricted solely to use with the forks described above. The linkage mechanism would work equally well on larger or smaller scale machines including but not limited to forklifts where there is a pivoting member that is being caused to pivot under the action of a ram.

Finally, the link arms could both be straight or one or both could be arcuate in shape. By having the link arm arcuate in shape, greater flexibility of movement of the linkage will be achievable without having to alter the casing of the extendable boom to accommodate the linkage.

In this specification the terms “comprise, comprises, comprised and comprising” and the terms “include, includes, included and including” are deemed totally interchangeable and should be afforded the widest possible interpretation.

This invention is in no way limited to the embodiments hereinbefore described but may be varied in both construction and detail within the scope of the claims.

1. A piggyback forklift truck for mounting on the rear of a carrying vehicle comprising:
a U-shaped chassis having a rear crossbar bridged by a pair of forwardly projecting side plates;
a ground engaging wheel mounted adjacent the forwardmost end of each of the side plates;
a steerable rear wheel mounted centrally on the rear crossbar;
a driver's station mounted on one of the side plates;
a motive power unit mounted on the other of the side plates;
a lifting assembly mounted on the chassis, the lifting assembly comprising:
a carriage slidably mounted on the chassis and moveable back and forth between the side plates towards and away from the rear crossbar;
means to move the carriage forwards and backwards on the chassis;
an upright boom support mounted on the carriage;
an extendable boom, pivotally mounted adjacent its proximal end to the uppermost end of the upright boom support, the extendable boom having a fork carrier carrying forks mounted on the distal end thereof;
means to pivot the extendable boom about its pivot on the upright boom support; and
means to extend or reduce the length of the boom to move the fork carrier towards or away from the uppermost end of the upright boom support.

2. The piggyback forklift truck as claimed in claim 1 in which the extendable boom further comprises:
an outer casing pivotally mounted to the upright boom support; and
an inner casing slidably mounted on the outer casing.

3. The piggyback forklift truck as claimed in claim 2 in which the means to extend or reduce the length of the extendable boom further comprises an extension ram connected at one of its ends to the outer casing of the extendable boom and connected at its other end to the inner casing of the extendable boom.

4. The piggyback forklift truck as claimed in claim 1 in which the upright boom support and the extendable boom are dimensioned to allow the extendable boom to pivot to and from a closed position whereby the extendable boom is substantially orthogonal to the ground with the distal end of the extendable boom facing the ground and an open position with the distal end of the boom facing upwards and away from the ground.

5. The piggyback forklift truck as claimed in claim 1 in which the upright boom support and the extendable boom are dimensioned to allow the extendable boom to pivot to and from a closed position whereby the extendable boom is substantially orthogonal to the ground with the distal end of the extendable boom facing the ground and an open position with the distal end of the boom facing upwards and away from the ground, and in which the upright boom support further comprises a pair of spaced apart upright support arms mounted on the carriage, the extendable boom being pivotally mounted therebetween and nestable within the spaced apart upright support arms.

6. The piggyback forklift truck as claimed in claim 1 in which the upright boom support and the extendable boom are dimensioned to allow the extendable boom to pivot to and from a closed position whereby the extendable boom is substantially orthogonal to the ground with the distal end of the extendable boom facing the ground and an open position with the distal end of the boom facing upwards and away from the ground, and in which the extendable boom is provided with a pair of pivot arms protruding outwardly therefrom, the extendable boom being mounted on the upright boom support about the pivot arms.

7. The piggyback forklift truck as claimed in claim 1 in which the upright boom support and the extendable boom are dimensioned to allow the extendable boom to pivot to and from a closed position whereby the extendable boom is substantially orthogonal to the ground with the distal end of the extendable boom facing the ground and an open position with the distal end of the boom facing upwards and away from the ground, and in which the upright boom support is provided with a pair of forwardly projecting pivot arms adjacent the upper end thereof, the extendable boom being mounted on the upright boom support about the pivot arms.

8. The piggyback forklift truck as claimed in claim 1 in which the extendable boom further comprises a telescopic boom having a plurality of boom sections nestably and slidably mounted with respect to each other.

9. The piggyback forklift truck as claimed in claim 1 in which the means to pivot the extendable boom about its pivot on the upright boom support further comprises a lift ram, one end of the lift ram being mounted on the carriage, the other end of the lift ram being connected to the extendable boom.

10. The piggyback forklift truck as claimed in claim 1 in which the means to pivot the extendable boom about its pivot point further comprises a pair of lift rams, each of the lift rams being mounted at one of their ends on the carriage and connected at their other end to the extendable boom, one of the lift rams comprising a high pressure lift ram and the other of the lift rams comprising a low pressure lift ram.

11. The piggyback forklift truck as claimed in claim 10 in which the extendable boom further comprises a compensation jack connected at one end to the fork carrier and at its other end to the extendable boom and means to sequence the fluid supply of the compensating jack with the fluid supply of the high pressure lift ram.

12. The piggyback forklift truck as claimed in claim 11 in which there is provided means to transfer excess fluid pressure from the compensating jack to the high pressure lift ram.

13. The piggyback forklift truck as claimed in claim 1 in which there is further provided a compensation jack connected at one end to the fork carrier and at its other end to the extendable boom, the compensation jack further comprising a controllable tilt ram and a compensating ram connected together in an end to end manner, the controllable tilt ram having a tilt ram cylinder with an internal bore and a tilt ram piston partially housed in the tilt ram bore, the compensating ram having a compensating ram cylinder with an internal bore and a compensation ram piston partially housed in the compensating ram bore, the tilt ram cylinder and the compensation ram cylinder being connected together in an end to end manner.

14. The piggyback forklift truck as claimed in claim 1 in which there is provided a compensation jack connected at one end to the fork carrier and at its other end to the extendable boom, the compensating jack being housed internal the extendable boom.

15. The piggyback forklift truck as claimed in claim 1 in which there is provided a compensation jack, one end of which is connected to the extendable boom and the other end of which is connected to the fork carrier by way of a linkage mechanism, the linkage mechanism comprising a pair of elongate link arms, each of the link arms being pivotally mounted at one of their ends to the compensating jack, the other ends of the link arms being pivotally mounted on the fork carrier and spaced apart from each other on the fork carrier.

16. The piggyback loader as claimed in claim 15 in which one of the elongate link arms is arcuate in shape.

17. The piggyback forklift truck as claimed in claim 1 in which the carriage further comprises a plurality of rollers and in which each of the side plates are further provided with a track for reception of at least one carriage roller, the carriage capable of sliding forwards and backwards along the chassis relative the rear crossbar along the rollers in the tracks.

18. The piggyback forklift as claimed in claim 1 in which the telescopic boom is hexagonal in cross-section.

19. A piggyback forklift truck for mounting on the rear of a carrying vehicle comprising:
a U-shaped chassis having a rear crossbar bridged by a pair of forwardly projecting side plates;
a ground engaging wheel mounted adjacent the forwardmost end of each of the side plates;
a steerable rear wheel mounted centrally on the rear crossbar;
a driver's station mounted on one of the side plates;
a motive power unit mounted on the other of the side plates;
a lifting assembly mounted on the chassis, the lifting assembly comprising:
a carriage slidably mounted on the chassis and moveable back and forth between the side plates towards and away from the rear crossbar;
means to move the carriage forwards and backwards on the chassis;
an upright boom support mounted on the carriage;
an extendable boom, pivotally mounted adjacent its proximal end to the uppermost end of the upright boom support, the extendable boom further comprising an outer casing pivotally mounted on the upright boom support and an inner casing slidably mounted on the outer casing;
a fork carrier mounted on the distal end of the extendable boom;
forks mounted on the fork carrier;
means to pivot the extendable boom about its pivot on the upright boom support; and
means to extend or reduce the length of the boom to move the fork carrier towards or away from the uppermost end of the upright boom support.

20. The piggyback forklift truck as claimed in claim 19 in which the means to extend or reduce the length of the extendable boom further comprises an extension ram connected at one of its ends to the outer casing of the extendable boom and connected at its other end to the inner casing of the extendable boom.

21. The piggyback forklift truck as claimed in claim 19 in which the upright boom support and the extendable boom are dimensioned to allow the extendable boom to pivot to and from a closed position whereby the extendable boom is substantially orthogonal to the ground with the distal end of the extendable boom facing the ground and an open position with the distal end of the boom facing upwards and away from the ground.

22. The piggyback forklift truck as claimed in claim 19 in which the upright boom support and the extendable boom are dimensioned to allow the extendable boom to pivot to and from a closed position whereby the extendable boom is substantially orthogonal to the ground with the distal end of the extendable boom facing the ground and an open position with the distal end of the boom facing upwards and away from the ground, and in which the upright boom support further comprises a pair of spaced apart upright support arms mounted on the carriage, the extendable boom being pivotally mounted therebetween and nestable within the spaced apart upright support arms.

23. The piggyback forklift truck as claimed in claim 19 in which the upright boom support and the extendable boom are dimensioned to allow the extendable boom to pivot to and from a closed position whereby the extendable boom is substantially orthogonal to the ground with the distal end of the extendable boom facing the ground and an open position with the distal end of the boom facing upwards and away from the ground, and in which the extendable boom is provided with a pair of pivot arms protruding outwardly therefrom, the extendable boom being mounted on the upright boom support about the pivot arms.

24. The piggyback forklift truck as claimed in claim 19 in which the upright boom support and the extendable boom are dimensioned to allow the extendable boom to pivot to and from a closed position whereby the extendable boom is substantially orthogonal to the ground with the distal end of the extendable boom facing the ground and an open position with the distal end of the boom facing upwards and away from the ground, and in which the upright boom support is provided with a pair of forwardly projecting pivot arms adjacent the upper end thereof, the extendable boom being mounted on the upright boom support about the pivot arms.

25. The piggyback forklift truck as claimed in claim 19 in which the means to pivot the extendable boom about its pivot on the upright boom support further comprises a lift ram, one end of the lift ram being mounted on the carriage, the other end of the lift ram being connected to the extendable boom.

26. The piggyback forklift truck as claimed in claim 19 in which the means to pivot the extendable boom about its pivot point further comprises a pair of lift rams, each of the lift rams being mounted at one of their ends on the carriage and connected at their other end to the extendable boom, one of the lift rams comprising a high pressure lift ram and the other of the lift rams comprising a low pressure lift ram.

27. The piggyback forklift truck as claimed in claim 26 in which the extendable boom further comprises a compensation jack connected at one end to the fork carrier and at its other end to the extendable boom and means to sequence the fluid supply of the compensating jack with the fluid supply of the high pressure lift ram.

28. The piggyback forklift truck as claimed in claim 27 in which there is provided means to transfer excess fluid pressure from the compensating jack to the high pressure lift ram.

29. The piggyback forklift truck as claimed in claim 19 in which there is further provided a compensation jack connected at one end to the fork carrier and at its other end to the extendable boom, the compensation jack further comprising a controllable tilt ram and a compensating ram connected together in an end to end manner, the controllable tilt ram having a tilt ram cylinder with an internal bore and a tilt ram piston partially housed in the tilt ram bore, the compensating ram having a compensating ram cylinder with an internal bore and a compensation ram piston partially housed in the compensating ram bore, the tilt ram cylinder and the compensation ram cylinder being connected together in an end to end manner.

30. The piggyback forklift truck as claimed in claim 19 in which there is provided a compensation jack connected at one end to the fork carrier and at its other end to the extendable boom, the compensating jack being housed internal the extendable boom.

31. The piggyback forklift truck as claimed in claim 19 in which the carriage further comprises a plurality of rollers and in which each of the side plates are further provided with a track for reception of at least one carriage roller, the carriage capable of sliding forwards and backwards along the chassis relative the rear crossbar along the rollers in the tracks.

32. A piggyback forklift truck for mounting on the rear of a carrying vehicle comprising:
a U-shaped chassis having a rear crossbar bridged by a pair of forwardly projecting side plates;
a ground engaging wheel mounted adjacent the forwardmost end of each of the side plates;
a steerable rear wheel mounted centrally on the rear crossbar;
a driver's station mounted on one of the side plates;
a motive power unit mounted on the other of the side plates;
a lifting assembly mounted on the chassis, the lifting assembly comprising:
a carriage slidably mounted on the chassis and moveable back and forth between the side plates towards and away from the rear crossbar;
means to move the carriage forwards and backwards on the chassis;
an upright boom support mounted on the carriage;
an extendable boom, pivotally mounted adjacent its proximal end to the uppermost end of the upright boom support, the extendable boom having a fork carrier carrying forks mounted on the distal end thereof;
means to pivot the extendable boom about its pivot on the upright boom support;
means to extend or reduce the length of the boom to move the fork carrier towards or away from the uppermost end of the upright boom support; and
the upright boom support and the extendable boom are dimensioned to allow the extendable boom to pivot to and from a closed position whereby the extendable boom is substantially orthogonal to the ground with the distal end of the extendable boom facing the ground and an open position with the distal end of the boom facing upwards and away from the ground.

33. The piggyback forklift truck as claimed in claim 32 in which the upright boom support further comprises a pair of spaced apart upright support arms mounted on the carriage, the extendable boom being pivotally mounted therebetween and nestable within the spaced apart upright support arms.

34. The piggyback forklift truck as claimed in claim 32 in which the extendable boom is provided with a pair of pivot arms protruding outwardly therefrom, the extendable boom being mounted on the upright boom support about the pivot arms.

35. The piggyback forklift truck as claimed in claim 32 in which the upright boom support is provided with a pair of forwardly projecting pivot arms adjacent the upper end thereof, the extendable boom being mounted on the upright boom support about the pivot arms.

36. The piggyback forklift truck as claimed in claim 32 in which the means to pivot the extendable boom about its pivot on the upright boom support further comprises a lift ram, one end of the lift ram being mounted on the carriage, the other end of the lift ram being connected to the extendable boom.

37. The piggyback forklift truck as claimed in claim 32 in which the means to pivot the extendable boom about its pivot point further comprises a pair of lift rams, each of the lift rams being mounted at one of their ends on the carriage and connected at their other end to the extendable boom, one of the lift rams comprising a high pressure lift ram and the other of the lift rams comprising a low pressure lift ram.

38. The piggyback forklift truck as claimed in claim 37 in which the extendable boom further comprises a compensation jack connected at one end to the fork carrier and at its other end to the extendable boom and means to sequence the fluid supply of the compensating jack with the fluid supply of the high pressure lift ram.

39. The piggyback forklift truck as claimed in claim 38 in which there is provided means to transfer excess fluid pressure from the compensating jack to the high pressure lift ram.

40. The piggyback forklift truck as claimed in claim 32 in which there is further provided a compensation jack connected at one end to the fork carrier and at its other end to the extendable boom, the compensation jack further comprising a controllable tilt ram and a compensating ram connected together in an end to end manner, the controllable tilt ram having a tilt ram cylinder with an internal bore and a tilt ram piston partially housed in the tilt ram bore, the compensating ram having a compensating ram cylinder with an internal bore and a compensation ram piston partially housed in the compensating ram bore, the tilt ram cylinder and the compensation ram cylinder being connected together in an end to end manner.

41. The piggyback forklift truck as claimed in claim 32 in which there is provided a compensation jack connected at one end to the fork carrier and at its other end to the extendable boom, the compensating jack being housed internal the extendable boom.

42. The piggyback forklift truck as claimed in claim 1 in which the carriage further comprises a plurality of rollers and in which each of the side plates are further provided with a track for reception of at least one carriage roller, the carriage capable of sliding forwards and backwards along the chassis relative the rear crossbar along the rollers in the tracks.

43. A piggyback forklift truck for mounting on the rear of a carrying vehicle comprising:
a U-shaped chassis having a rear crossbar bridged by a pair of forwardly projecting side plates;
a ground engaging wheel mounted adjacent the forwardmost end of each of the side plates;
a steerable rear wheel mounted centrally on the rear crossbar;
a driver's station mounted on one of the side plates;
a motive power unit mounted on the other of the side plates;
a lifting assembly mounted on the chassis, the lifting assembly comprising:
a carriage slidably mounted on the chassis and moveable back and forth between the side plates towards and away from the rear crossbar;
a plurality of rollers mounting the carriage in a track in each of the side plates;
means to move the carriage forwards and backwards on the rollers in the tracks along the side plates;
an upright boom support mounted on the carriage;
an extendable boom, pivotally mounted adjacent its proximal end to the uppermost end of the upright boom support, the extendable boom having a fork carrier carrying forks mounted on the distal end thereof;
means to pivot the extendable boom about its pivot on the upright boom support; and
means to extend or reduce the length of the boom to move the fork carrier towards or away from the uppermost end of the upright boom support.

44. The piggyback forklift truck as claimed in claim 43 in which the upright boom support and the extendable boom are dimensioned to allow the extendable boom to pivot to and from a closed position whereby the extendable boom is substantially orthogonal to the ground with the distal end of the extendable boom facing the ground and an open position with the distal end of the boom facing upwards and away from the ground.

45. The piggyback forklift truck as claimed in claim 43 in which the upright boom support and the extendable boom are dimensioned to allow the extendable boom to pivot to and from a closed position whereby the extendable boom is substantially orthogonal to the ground with the distal end of the extendable boom facing the ground and an open position with the distal end of the boom facing upwards and away from the ground, and in which the upright boom support further comprises a pair of spaced apart upright support arms mounted on the carriage, the extendable boom being pivotally mounted therebetween and nestable within the spaced apart upright support arms.

46. The piggyback forklift truck as claimed in claim 43 in which the upright boom support and the extendable boom are dimensioned to allow the extendable boom to pivot to and from a closed position whereby the extendable boom is substantially orthogonal to the ground with the distal end of the extendable boom facing the ground and an open position with the distal end of the boom facing upwards and away from the ground, and in which the extendable boom is provided with a pair of pivot arms protruding outwardly therefrom, the extendable boom being mounted on the upright boom support about the pivot arms.

47. The piggyback forklift truck as claimed in claim 43 in which the upright boom support and the extendable boom are dimensioned to allow the extendable boom to pivot to and from a closed position whereby the extendable boom is substantially orthogonal to the ground with the distal end of the extendable boom facing the ground and an open position with the distal end of the boom facing upwards and away from the ground, and in which the upright boom support is provided with a pair of forwardly projecting pivot arms adjacent the upper end thereof, the extendable boom being mounted on the upright boom support about the pivot arms.

48. The piggyback forklift truck as claimed in claim 43 in which the means to pivot the extendable boom about its pivot on the upright boom support further comprises a lift ram, one end of the lift ram being mounted on the carriage, the other end of the lift ram being connected to the extendable boom.

49. The piggyback forklift truck as claimed in claim 43 in which the means to pivot the extendable boom about its pivot point further comprises a pair of lift rams, each of the lift rams being mounted at one of their ends on the carriage and connected at their other end to the extendable boom, one of the lift rams comprising a high pressure lift ram and the other of the lift rams comprising a low pressure lift ram.

50. The piggyback forklift truck as claimed in claim 49 in which the extendable boom further comprises a compensation jack connected at one end to the fork carrier and at its other end to the extendable boom and means to sequence the fluid supply of the compensating jack with the fluid supply of the high pressure lift ram.

51. The piggyback forklift truck as claimed in claim 50 in which there is provided means to transfer excess fluid pressure from the compensating jack to the high pressure lift ram.

52. The piggyback forklift truck as claimed in claim 43 in which there is further provided a compensation jack connected at one end to the fork carrier and at its other end to the extendable boom, the compensation jack further comprising a controllable tilt ram and a compensating ram connected together in an end to end manner, the controllable tilt ram having a tilt ram cylinder with an internal bore and a tilt ram piston partially housed in the tilt ram bore, the compensating ram having a compensating ram cylinder with an internal bore and a compensation ram piston partially housed in the compensating ram bore, the tilt ram cylinder and the compensation ram cylinder being connected together in an end to end manner.

53. The piggyback forklift truck as claimed in claim 43 in which there is provided a compensation jack connected at one end to the fork carrier and at its other end to the extendable boom, the compensating jack being housed internal the extendable boom.
